(19) United States
(12) Patent Application Publication
(10) Pub. No.: US 2012/0267389 A1
(43) Pub. Date: Oct. 25, 2012

(54) APPARATUS AND METHOD FOR DELIVERING BENEFICIAL LIQUIDS AT A CONSISTENT RATE

(76) Inventors: John Howard Gordon, Salt Lake City, UT (US); Ashok V. Joshi, Salt Lake City, UT (US); Truman Wold, Paauilo, HI (US); Sai Bhavaraju, West Jordan, UT (US)

(21) Appl. No.: 13/523,015

(22) Filed: Jun. 14, 2012

Related U.S. Application Data
(63) Continuation-in-part of application No. 13/281,282, filed on Oct. 25, 2011, now Pat. No. 8,240,260.
Application No. 13/281,282 is a division of application No. 12/550,050, filed on Aug. 28, 2009, now Pat. No. 8,061,280.
Application No. 12/550,050 is a continuation-in-part of application No. 12/100,982, filed on Apr. 10, 2008, now Pat. No. 7,658,156.

(51) Int. Cl. B67D 7/76

(52) U.S. Cl. 222/1; 222/189.06

(57) ABSTRACT

An apparatus for providing controlled delivery of a beneficial agent is disclosed. In one embodiment, such an apparatus includes a water chamber and a filter to produce filtered water by removing impurities from water introduced into the water chamber. A water-transporting membrane transports filtered water from the water chamber to an extraction chamber, thereby expanding the extraction chamber. The extraction chamber contains an osmagent that provides the driving force to pull the filtered water through the water-transporting membrane. As the extraction chamber expands, a dispensing chamber containing a beneficial agent contracts. This causes the beneficial agent to be expelled through a port in communication with the dispensing chamber. A corresponding method is also disclosed.

### CROSS-REFERENCE TO RELATED APPLICATION

This application is a continuation-in-part of U.S. patent application Ser. No. 13/281,282 filed Oct. 25, 2011 and entitled APPARATUS FOR DELIVERING BENEFICIAL LIQUIDS AT STEADY RATE, which is a divisional application of U.S. Pat. No. 8,061,280 filed Aug. 28, 2009 and entitled APPARATUS AND METHOD FOR DELIVERING BENEFICIAL LIQUIDS AT STEADY RATE, which is a continuation-in-part of U.S. Pat. No. 7,658,156 filed Apr. 10, 2008 and entitled APPARATUS AND METHOD FOR DELIVERING BENEFICIAL AGENTS TO SUBTERRANEAN LOCATIONS. The foregoing patents and applications are hereby incorporated by reference.

### BACKGROUND

This invention relates to apparatus and methods for delivering beneficial liquids such as fragrances, deodorizers, sanitizers, pesticides and pest repellants at a steady rate for extended time periods using an osmotic pump and where the source of water for the osmosis typically is not continuously refreshed.

What are needed are apparatus and methods for delivering liquid beneficial agents, such as fragrances, deodorizers, sanitizers, pesticides, and pest repellants in a controlled, predictable manner. Ideally, such apparatus and methods would be suitable to disperse a wide variety of different beneficial liquids which may be solutions, suspensions, or mixtures. Further needed are apparatus and methods for easily controlling the rate at which the beneficial agents are released.

Many have investigated delivering liquids using osmotic engines. In general, an osmagent is contained in a variable volume container that in part includes a semipermeable membrane and also communicates with a container containing a beneficial agent through a flexible diaphragm, piston, or such. Upon activation, the semipermeable membrane is exposed to a source of water. Water flows through the semipermeable membrane into the osmagent container, expanding the volume, which in turn forces the beneficial agent to be expelled. In some cases the devices are implanted into the body of an animal or human where the body is the source of water. In other cases, the water is supplied from a reservoir contained in the device.

Herbig et al. in U.S. Pat. No. 5,798,119 disclosed a device used for delivering fluids such as fragrances and insecticides. They use a hydrophobic microporous separator to separate an osmagent from liquid water. Water vapor passes through the hydrophobic membrane from the liquid water to the osmagent, increasing the volume where the osmagent is located. The volume increase drives the delivery of the beneficial agent. A disadvantage of this approach is that water vapor pressure is very temperature dependant. For example, water vapor pressure is 20× higher at 50° C. compared to 0° C. Looking at a narrower temperature range, the vapor pressure at 10° C. is 56 percent lower than at 23° C. and at 44° C. the vapor pressure is 326 percent higher than at 23° C. Thus temperature variations will have a very large impact on the dispense rate with this type of system which is very undesirable in most cases.

Faste in U.S. Pat. No. 4,898,582 and Atahyde et al. in U.S. Pat. No. 5,672,167 disclosed drug infusion devices using osmosis where the water was contained within the device. These inventors disclosed systems utilizing cellulose ester or cellulose ether membranes such as cellulose acetate as the semipermeable membrane between the osmagent and the water source. An advantage of these membranes over the hydrophobic membranes disclosed by Herbig et al. is the fact that liquid water diffuses through the semipermeable membranes rather than water vapor. This significantly reduces the temperature sensitivity of the osmosis since the concentration of water is substantially unchanged over a temperature range as opposed to widely varying water vapor pressure. A disadvantage of these membranes is that while they are substantially semipermeable, they still have permeability to many potential osmagents. As a result, the osmagent can permeate into the water container as well as water diffusing into the osmagent container. While the diffusion of osmagent is small, the effect over time can be very large when the volume of water contained is near the same amount of liquid to be dispensed and especially if the time scale of delivery is long. As osmagent diffuses into the water container, the driving force for diffusion of water across the semipermeable membrane is reduced and the delivery rate declines over time.

Several inventors such as Wong et al. in U.S. Pat. No. 4,874,388 and Chen et al. in U.S. Pat. No. 6,923,800 disclose osmotically driven devices where the devices are implanted into the body of an animal or man where the water is supplied by the body and where the concentration of the water near the semipermeable membrane remains nearly the same over time due to the active nature of the body. Wong et al. describe the use of “cellulosic polymers such as cellulose acetate, ethyl cellulose, methylcellulose, cellulose acetate butyrate, cellulose acetate propionate, blends of impermeable material and hydrophilic polymer or a molecular weight water soluble enhancer to render the material semipermeable.” Chen et al. on the other hand disclose using polyurethane materials which are somewhat permeable to water for low rate devices.

The prior art does not teach how to obtain steady fluxes of water through a semipermeable membrane where osmagent is on one side and a non-continuously refreshed water source is on the other side and where variations in the flux rate due to changes in temperature are minimal.

### SUMMARY OF THE INVENTION

The invention has been developed in response to the present state of the art and, in particular, in response to the problems and needs in the art that have not yet been fully solved by currently available apparatus and methods. Accordingly, the invention has been developed to provide apparatus and methods to provide controlled delivery of beneficial agents at a consistent rate. The features and advantages of the invention will become more fully apparent from the following description and appended claims, or may be learned by practice of the invention as set forth hereinafter.

Consistent with the foregoing, an apparatus for providing controlled delivery of a beneficial agent is disclosed. In one embodiment, such an apparatus includes a water chamber and a filter to produce filtered water by removing impurities from water introduced into the water chamber. A water-transporting membrane transports filtered water from the water chamber to an extraction chamber, thereby expanding the extraction chamber. The extraction chamber contains an osmagent that provides the driving force to pull the filtered water through the water-transporting membrane. As the extraction chamber expands, a dispensing chamber containing a beneficial agent contracts. This causes the beneficial agent to be expelled through a port in communication with the dispensing chamber.

In another aspect of the invention, a method for providing controlled delivery of a beneficial agent is disclosed. In one embodiment, such a method includes receiving water into a water chamber and filtering the water to produce filtered water. The filtered water may then be transported through a water-transporting membrane into an extraction chamber. The extraction chamber contains an osmagent that provides the driving force to pull the filtered water through the water-transporting membrane. The method further comprises contracting a dispensing chamber in response to expanding the extraction chamber. Contracting the dispensing chamber causes a beneficial agent to be dispensed from the dispensing chamber.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings in which:

FIG. 1 is a cutaway view of one embodiment of an apparatus in accordance with the invention;

FIG. 1A is a cutaway view of a portion of the housing of FIG. 1;

FIG. 1B is a cutaway view of a portion of the diaphragm of FIG. 1;

FIG. 2 is a top view of a first component of the rate adjustment mechanism of FIG. 1;

FIG. 3 is a top view of a second component of the rate adjustment mechanism of FIG. 1;

FIG. 4 is a graph showing an amount of liquid dispensed over a twenty day period for six devices in accordance with the invention with different membrane areas exposed;

FIG. 5 is a graph showing the same data illustrated in FIG. 4 expressed in terms of an incremental delivery rate over time;

FIG. 6 is a graph showing the delivery rate of three devices in accordance with the invention, where each device was operated at a different temperature;

FIG. 7 is a cutaway view showing one example of a filter incorporated into an apparatus in accordance with the invention;

FIG. 8 is a cutaway view showing another example of a filter incorporated into an apparatus in accordance with the invention;

FIG. 9 is a graph showing an amount of liquid dispensed over a twenty-eight day period for three devices using filtered (distilled) water;

FIG. 10 is a graph showing the same data illustrated in FIG. 9 expressed in terms of an incremental delivery rate over time;

FIG. 11 is a graph showing an amount of liquid dispensed over a twenty-eight day period for three devices using filtered (distilled) water compared to three devices using non-filtered (tap) water; and

FIG. 12 is a graph showing the same data illustrated in FIG. 11 expressed in terms of an incremental delivery rate over time.

### DETAILED DESCRIPTION OF THE INVENTION

The invention has been developed in response to the present state of the art and, in particular, in response to the problems and needs in the art that have not yet been fully solved by currently available devices for delivering liquid beneficial agents such as fragrances, deodorizers, sanitizers, pesticides, and pest repellants. Such devices either suffer from a decline in delivery performance over time to the point that the benefits are no longer rendered or when the devices are active and have acceptable performance, the devices are complex in nature which results in high cost. Accordingly, the invention has been developed to provide novel apparatus and methods for delivering liquid beneficial agents to target areas in a controlled and predictable manner and where impact of temperature variation is minimal. The features and advantages of the invention will become more fully apparent from the following description and appended claims and their equivalents, and also any subsequent claims or amendments presented, or may be learned by practice of the invention as set forth hereinafter. The devices can stand alone and do not require power or external connections.

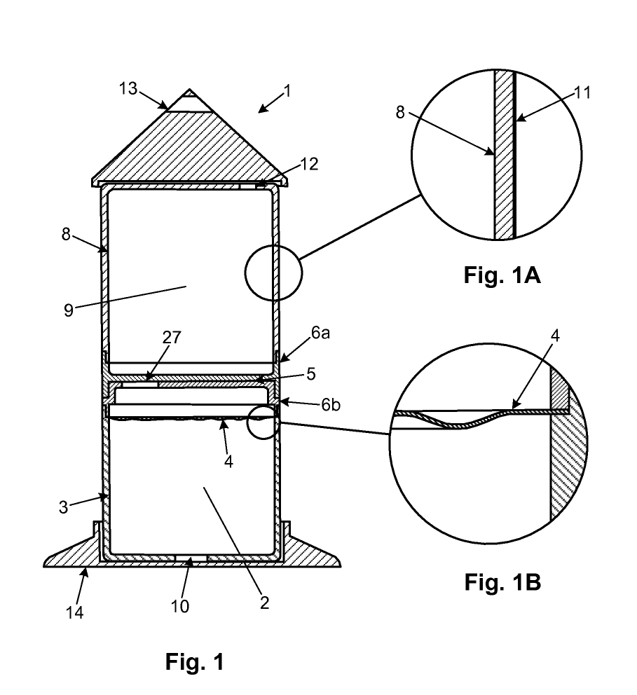

FIG. 1 schematically shows one embodiment of a device 1 for delivering a beneficial agent 2. The beneficial agent 2 is in container 3 of substantially rigid walls with the exception of a flexible bellows 4 or diaphragm 4 that enables the volume of the container 3 to contract. An ion exchange membrane 5 separates the flexible bellows 4 from the water 9 containing chamber 8. A first adjustment member 6a has openings 7 (not shown). Depending on the position of the adjustment member 6a relative to a second adjustment member 6b, the membrane 5 may be obscured or an increasingly greater area of the membrane 5 may be exposed to the water 9 upon activation. A mass of osmagent (not shown), is located between the flexible bellows 4 and the membrane 5. The bellows 4 preferably comprises or is coated by materials of low water permeability such as metal or barrier polymer such as metalized PET (polyethylene terephthalate), Halar, PCTFE (polychlorotrifluoroethylene). Other polymers with relatively low water permeability that may be used include HDPE (high density polyethylene), PP (polypropylene), PEEK (polyetheretherketone), PET and FEP (fluorinated ethylene propylene). Upon activation, water 9 flows through the membrane 5 and increases the volume between the membrane 5 and the bellows 4. As this occurs, the beneficial agent 2 is expelled through the port 10. In this case, a wick may transport the beneficial agent 2 away from the port 10 and up the side walls of the device 1 so the beneficial agent 2 may more readily evaporate. The device is housed in a structure with a base 14 and a hanger 13 to provide multiple sites where the device can be located in a space such as a room. The water container 8 has a vent 12 with a hydrophobic microporous film that allows air to enter the water container 8 as water 9 transports across the membrane 5. Alternatively the water container 8 could have a flexible wall or a piston such that the volume diminishes as the water 9 transports out of the container 8.

It should be understood that FIG. 1 shows just one embodiment of the invention. The apparatus 1 could also be constructed such that the beneficial agent 2 is contained within a pouch or flexible bag that becomes compressed as water 9 transports into the zone between the membrane 5 and the flexible bellows 4. Also, the bellows 4 could be replaced with a flexible diaphragm or piston such that an expansion zone containing the osmagent receives the water 9 transporting across the membrane 5 and mechanically forces the beneficial agent 2 to be expelled from the apparatus 1.

In one embodiment, an apparatus to provide controlled delivery of a beneficial agent includes a water chamber, a water-transporting membrane in communication with the water collection chamber, an extraction chamber to receive water through the water-transporting membrane and into the extraction chamber, thereby expanding the extraction chamber, an osmagent in the extraction chamber, a dispensing chamber containing a beneficial agent and contracting in response to expanding the extraction chamber, and a port in communication with the dispensing chamber to deliver the beneficial agent.

In another embodiment, an apparatus to provide controlled delivery of a beneficial agent includes a water chamber, a water-transporting membrane in communication with the water collection chamber where the membrane has a membrane feature that repels one or more osmagent constituents, an extraction chamber to receive water through the water-transporting membrane and into the extraction chamber, thereby expanding the extraction chamber, an osmagent in the extraction chamber, a dispensing chamber containing a beneficial agent and contracting in response to expanding the extraction chamber, and a port in communication with the dispensing chamber to deliver the beneficial agent.

The osmagent repelling feature or structure of the membrane may be a functional group on the surface of the membrane, and may be of the class including a quaternary ammonium group or a sulfonate group, or a combination thereof. The osmagent repelling feature or structure of the membrane in one embodiment is a charged functional group within the membrane. The charged functional group within the membrane may be of the class including a sulfonate or a quaternary ammonium, or combinations thereof.

The membrane of the apparatus may be an ion exchange membrane. The ion exchange membrane in one embodiment may be chosen from the class consisting of an anion exchange membrane or a cation exchange membrane. In one embodiment, the ion exchange membrane has a polymer structure. The ion exchange membrane polymer structure may be one fluoropolymer or styrene divinyl benzene, or combinations thereof. In another embodiment, the ion exchange membrane may be chosen from the class consisting of Nafion by Dupont; Neosepta CMX, AMX, CIMS, CMB, AHA, ACM, ACS, AFN, AFX by ASTOM Corporation; Selemion by Asahi Glass, or combinations thereof.

The osmagent may be a salt. In one embodiment, the osmagent comprises at least one of ammonium and phosphate.

The apparatus includes an extraction chamber and a dispensing chamber that may be separated by a flexible diaphragm, piston, or other displacement member. In one embodiment, the flexible diaphragm comprises or is coated with a low water permeable material. The low water permeable material may be a metal, a metal coated polymer such as metalized PET (polyethylene terephthalate), Halar, PCTFE (polychlorotrifluoroethylene), HDPE (high density polyethylene), PP (polypropylene), PEEK (polyetheretherketone), PET, FEP (fluorinated ethylene propylene) or combinations thereof.

The apparatus in one embodiment may be configured such that at least one of the extraction chamber and the dispensing chamber is at least partially contained within a pouch. The pouch may comprise or be coated with a low or negligible water-permeable material. The low or negligible water permeable material may be a metal, a metal-coated polymer such as metalized PET (polyethylene terephthalate), Halar, PCTFE (polychlorotrifluoroethylene), HDPE (high density polyethylene), PP (polypropylene), PEEK (polyetheretherketone), PET, FEP (fluorinated ethylene propylene) or combinations thereof.

In one embodiment of the invention, the beneficial agent includes a fragrance.

The apparatus may further comprise a circuit to regulate electrical current flowing through the water-transporting membrane, thereby regulating water flowing through the water-transporting membrane into the extraction chamber. The apparatus may further comprise a rate adjustment mechanism to control the rate at which water is received through the water-transporting membrane. The rate adjustment mechanism may be a blind which obscures the water chamber from the water transporting membrane with varying degree.

The apparatus may include a water container that comprises a flexible wall such that the volume changes as water transports across the membrane. The water container may include a vent to allow gas to enter the container as water transports across the membrane. In one embodiment, the water container comprises a moveable wall.

A method for delivering a beneficial agent is also disclosed. The method may include the steps of collecting water into a water chamber, transporting the water through a water-transporting membrane into an extraction chamber containing an osmagent, thereby expanding the extraction chamber, dispensing a beneficial agent from a dispensing chamber in response to expanding the extraction chamber, and delivering the beneficial agent.

Expanding the extraction chamber may include deflecting a flexible diaphragm or moving a piston or other displacement member. The flexible diaphragm may comprise or be coated with a material with low or negligible water permeability. The material with low or negligible water permeability may be a metal, a metal coated polymer such as metalized PET (polyethylene terephthalate), Halar, PCTFE (polychlorotrifluoroethylene), HDPE (high density polyethylene), PP (polypropylene), PEEK (polyetheretherketone), PET, FEP (fluorinated ethylene propylene) or combinations thereof.

The water-transporting membrane may be in communication with the water chamber and the membrane may have a membrane feature that repels one or more osmagent constituents.

Referring now to FIG. 1A, a close up view of the container 8 is shown having a wicking layer 11 that extends down an outside surface of the container 8 to the port 10 of the device 1. In this case the wicking layer 11 or wick 11 may transport the beneficial agent 2 away from the port 10 and up the side walls of the device 1 so the beneficial agent 2 may more readily evaporate.

Referring now to FIG. 1B, a flexible bellows 4 or diaphragm 4 is shown that enables the volume of the container 3 to contract as fluid passes through the membrane 5. The bellows 4 preferably comprises or is coated by materials of low water permeability such as metal or barrier polymer such as metalized PET (polyethylene terephthalate), Halar, or PCTFE (polychlorotrifluoroethylene).

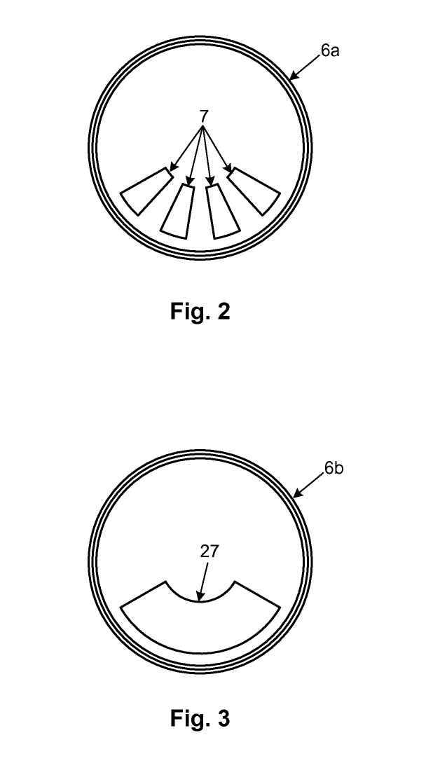

Referring now to FIGS. 2 and 3, a rate adjustment mechanism is shown. A first adjustment member 6a includes openings 7 radially extending from a midpoint of the first adjustment member 6a. A second adjustment member 6b includes an opening 27. The openings 7 and 27 in respective members 6a and 6b are placed adjacent to each other in the device 1 such that as adjustment member 6a is rotated relative to adjustment member 6b, more or less of the openings 7 and 27 overlap to allow water 9 to access the membrane 5 in different quantities. This in turn affects the rate at which the beneficial agent 2 is dispensed from the device 1.

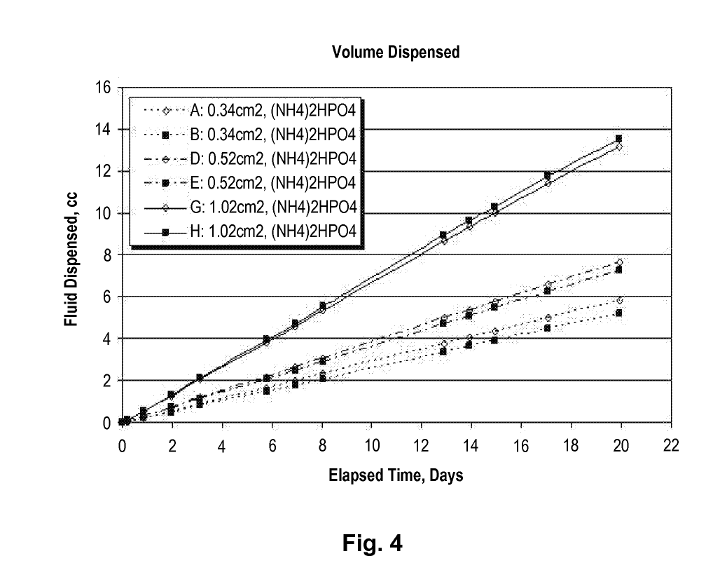

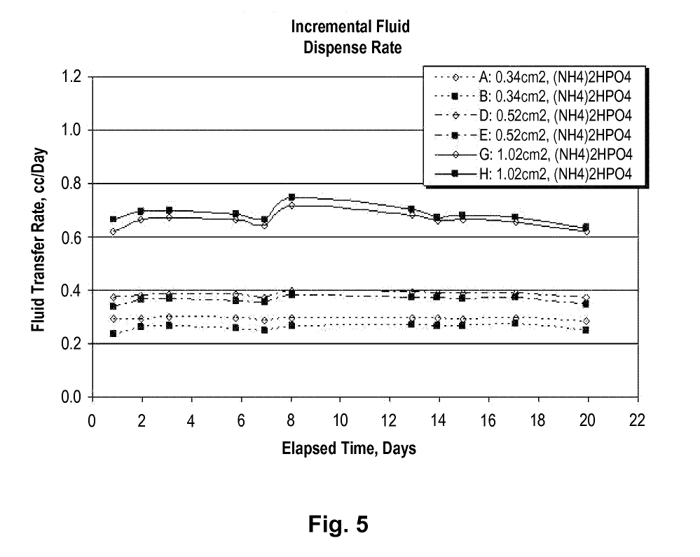

Referring now to FIGS. 4 and 5, six devices in accordance with the invention were constructed using Neosepta CMB ion exchange membrane from Astom Corporation. Two of the devices had 0.342 square centimeters of membrane exposed between an osmagent consisting of saturated ammonium phosphate dibasic and water. Two other devices had 0.519 square centimeters of membrane exposed between an osmagent consisting of saturated ammonium phosphate dibasic and water. Two additional devices had 1.026 square centimeters of membrane exposed between an osmagent consisting of saturated ammonium phosphate dibasic and water. Upon activation, the devices delivered beneficial agent approximately in proportion to the area of membrane exposed and at a steady rate as shown.

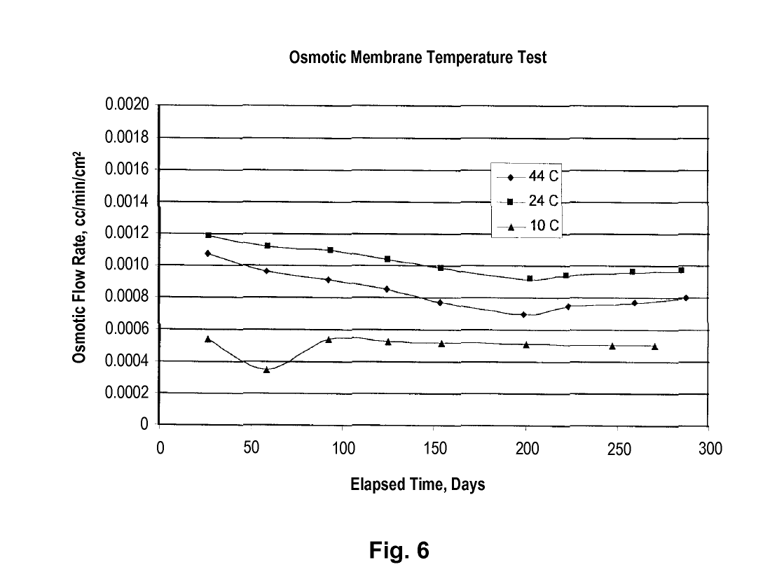

Referring to FIG. 6, three devices where constructed according to the teachings of the present invention with a Neosepta CMB membrane and ammonium phosphate dibasic osmagent. The exposed membrane area in each of the devices was approximately 10 square centimeters. One device was operated at 10° C., another at 24° C., and another at 44° C. The delivery rate over time is shown in FIG. 6. The rate of the device operated at 44° C. was approximately 83 percent of the rate of the device operated at 24° C. while the rate of the device operated at 10° C. was approximately 52 percent of the rate of the device operated at 24° C. These three rates while varied are much closer than they would be if a hydrophobic membrane was used to separate the water from the osmagent and water vapor was required to transport across the membrane.

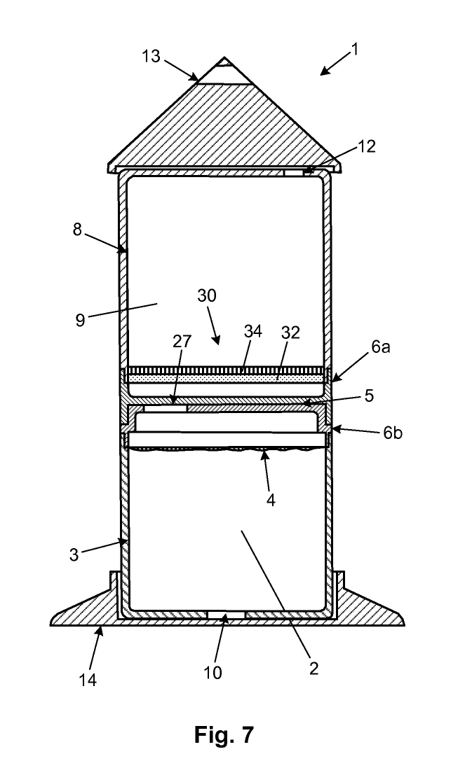

Referring to FIG. 7, in certain cases, filtered water may significantly improve the operation of the device 1. This is because unfiltered water may contain impurities that may impair the operation of the device over time. For example, over time, impurities (particulate matter, dissolved matter, etc.) may become lodged in or deposited on the membrane 5 to restrict the flow of water therethrough. Thus, even if a desired concentration gradient is maintained across the membrane 5, the flow of water across the membrane 5 may diminish over time. This, in turn, will change the rate that the beneficial agent 2 is dispensed from the device 1 over time. If the device 1 is dispensing a fragrance, for example, the fragrance will be dispensed in diminishing amounts, thereby decreasing the effectiveness of the device 1 over time.

Thus, in certain embodiments, it may be advantageous to utilize filtered water within the device 1 to provide a more consistent release rate over time. Unfortunately, requiring use of filtered water may be disadvantageous since filtered water may not always be readily available, or may incur additional expense to acquire. More often, tap water or other unfiltered water is readily available at little or no cost. Thus, in certain embodiments, it may be advantageous to incorporate a filter into the device 1. Such a filter may allow tap water or other unfiltered water to be added to the device 1, while ensuring that the unfiltered water does not impair the operation of the device 1 over time.

FIG. 7 shows one embodiment of a device 1 incorporating a filter 30. In this embodiment, the filter 30 includes a perforated structural member 34 and filter media 32. In one embodiment, the perforated structural member 34 provides physical support to the filter media 32, while the filter media 32 provides most if not all of the filtering capability. In other embodiments, the perforated structural member 34 retains the filter media 32 within the device 1 as opposed to physically supporting the filter media 32. In other embodiments, the perforated structural member 34 provides both a physical support and a retention function.

The filter media 32 may filter water added to the device 1 using various different filtering mechanisms, including but not limited to physical straining, chemical absorption, and ion-exchanging. In one embodiment, the filter media 32 contains activated carbon to remove contaminants and impurities by way of chemical absorption. The carbon may be activated with a positive charge in order to attract negatively charged impurities. Activated carbon may be effective to remove organics and non-polar molecules from water, in addition to absorbing chemicals such as chlorine, although it is less effective at removing minerals, salts, and dissolved inorganic compounds. If desired, other filtering layers or constituents may be added to the filter 30 to aid in removing minerals, salts, and dissolved inorganic compounds from the water.

In certain embodiments, the perforated structural member 34 also performs a filtering function. For example, in certain embodiments, the perforated structural member 34 is a microporous structure that physically strains the water. For example, in one embodiment, the perforated structural member 34 is a microporous ceramic structure that physically strains the water in addition to providing a structural support to and/or retention of the filter media 32. In other embodiments, the perforated structural member 34 is used to provide mechanical support to or retain a microporous membrane such as a microporous ceramic membrane.

In other embodiments, the perforated structural member 34 and filter media 32 are combined into a single layer. For example, the filter media 32 could be incorporated into a composite of sufficient mechanical strength that no additional support or retention mechanism is needed. In other embodiments, the filter media 32 includes multiple layers. For example, certain layers could remove impurities using chemical absorption, while other layers could remove particulate matter by physical sieving. Other layers could remove unwanted impurities using an ion-exchange process.

In certain embodiments, all or part of the filter 30 is replaceable. For example, one or more of the perforated structural member 34 and the filter media 32 may be replaceable. In other embodiments, the filter 30 is permanently affixed within the device 1. In such embodiments, the filter 30 may be intended to last the lifetime of the device 1 and be discarded with the device 1 when the lifetime has expired.

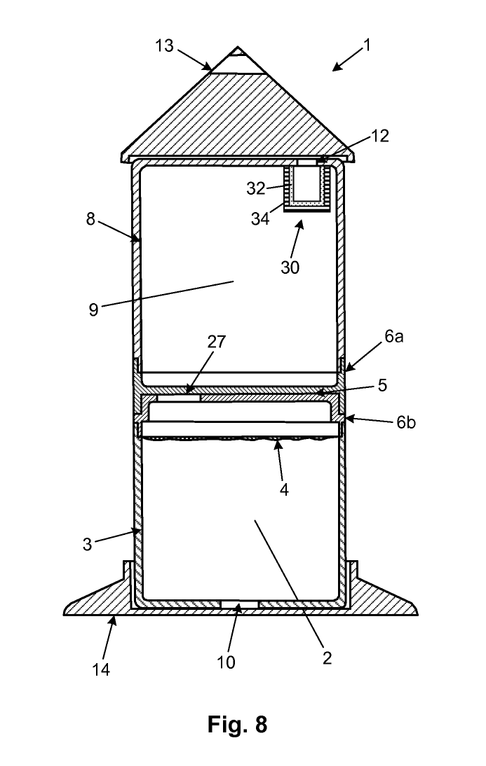

The placement of the filter 30 within the device 1 may vary. In FIG. 7, the filter 30 is placed adjacent to the water-transporting membrane 5. In such an embodiment, the water chamber 8 contains mostly unfiltered water. As water is drawn through the membrane 5, water is drawn through the filter 30 to supply filtered water to the membrane 5. In other embodiments, the filter 30 is provided at or near an inlet 12 (in this embodiment, the vent 12 previously described may also function as an inlet 12 to fill the device 1 with water). Such an embodiment is illustrated in FIG. 8. Alternatively, tap water may be poured through a filter 30 separate from the device 1, and then added to the device 1. Other locations for the filter 30 are possible and within the scope of the invention.

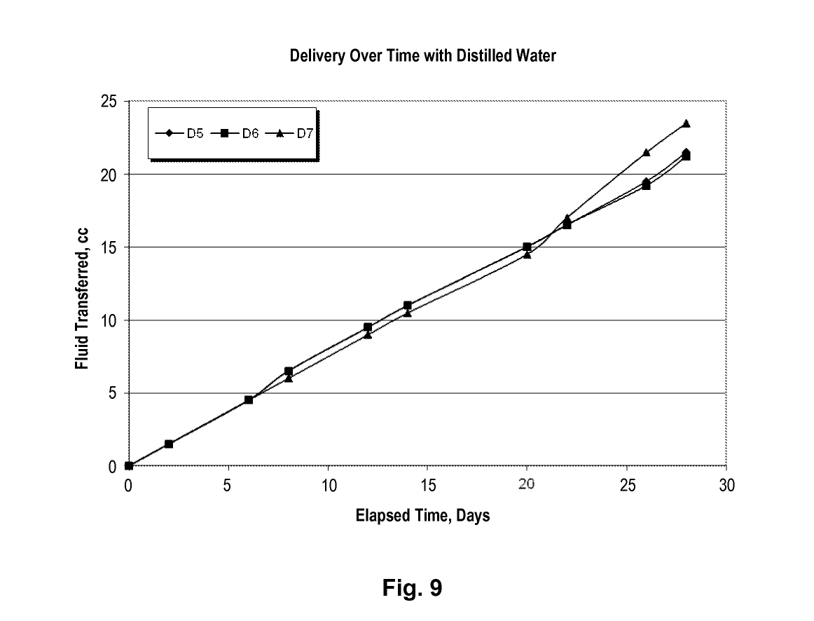

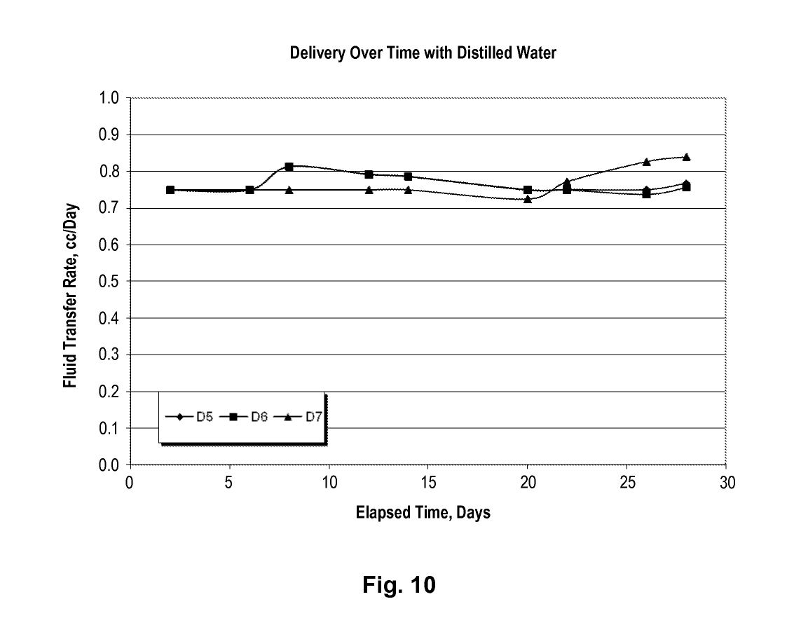

The performance of the device 1 improved remarkably when filtered water was used. FIG. 9 is graph showing an amount of liquid dispensed over a twenty-eight day period for three devices in accordance with the invention using filtered (distilled) water. As shown, the amount of fluid transferred stayed remarkably consistent over time for each of the devices (as indicated by the linearity of the graphs). FIG. 10 is a graph showing the same data illustrated in FIG. 9 expressed in terms of incremental delivery rate over time. As can be observed from FIG. 10, the fluid transfer rate was remarkably consistent over the twenty-eight day period for each of the devices when filtered water was used.

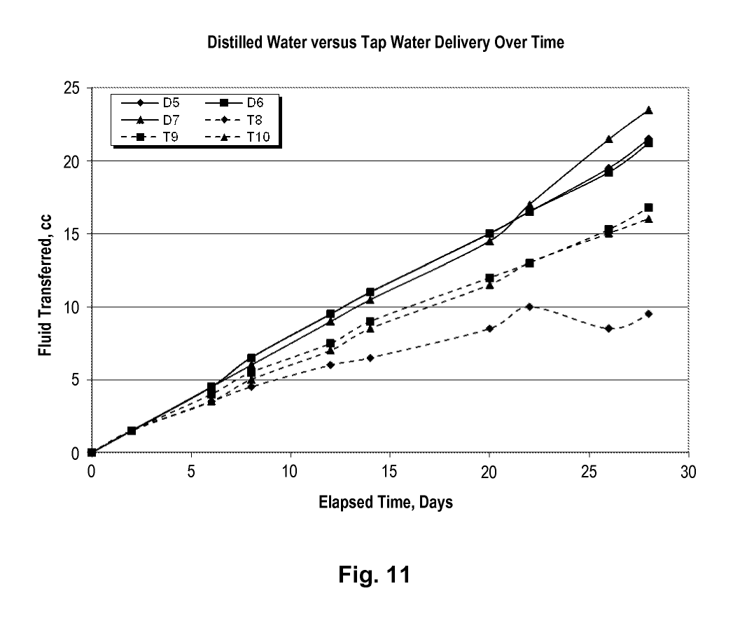

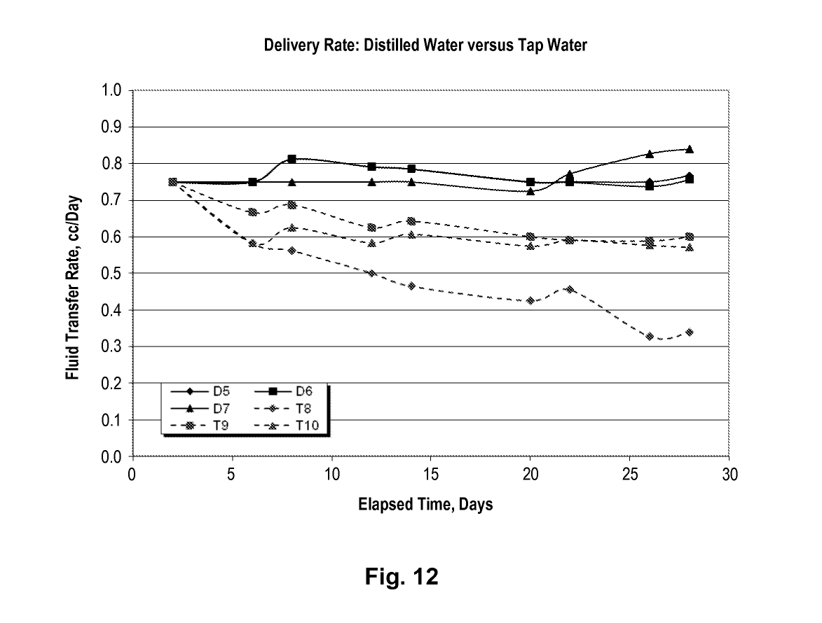

FIG. 11 is a graph showing an amount of liquid dispensed over a twenty-eight day period for three devices using filtered (distilled) water, and three devices using non-filtered (tap) water. The solid lines represent the devices using filtered water and the dashed lines represent the devices using unfiltered water. As can be observed, the amount of fluid dispensed by the devices using unfiltered water was significantly less than the amount of fluid dispensed by the devices using filtered water, most likely due to the clogging of the water-transporting membranes over time. FIG. 12 is a graph showing the same data illustrated in FIG. 11 expressed in terms of incremental delivery rate over time. As can be observed from FIG. 12, the fluid transfer rate diminished over time for each of the devices using unfiltered water, whereas the fluid transfer rate stayed remarkably consistent for each of the devices using filtered water.

The present invention may be embodied in other specific forms without departing from its basic principles or essential characteristics. The described embodiments are to be considered in all respects as illustrative and not restrictive. The scope of the invention is, therefore, indicated by the appended claims rather than by the foregoing description. All changes which come within the meaning and range of equivalency of the claims are to be embraced within their scope.

1. An apparatus to provide controlled delivery of a beneficial agent, the apparatus comprising:
a water chamber;
a filter to produce filtered water by removing impurities from water introduced into the water chamber;
a water-transporting membrane in communication with the water chamber;
an extraction chamber to receive the filtered water through the water-transporting membrane, thereby expanding the extraction chamber;
an osmagent in the extraction chamber;
a dispensing chamber containing a beneficial agent and contracting in response to expanding the extraction chamber; and
a port in communication with the dispensing chamber to deliver the beneficial agent.

2. The apparatus of claim 1, wherein the filter is substantially adjacent to the water-transporting membrane.

3. The apparatus of claim 1, wherein the filter is substantially adjacent to an inlet of the water chamber.

4. The apparatus of claim 1, wherein the filter comprises activated carbon.

5. The apparatus of claim 1, wherein the filter comprises a microporous membrane to physically strain the water.

6. The apparatus of claim 1, wherein the filter removes impurities from the water using at least one of the following filtering mechanisms: physical straining, chemical absorption, and ion-exchanging.

7. The apparatus of claim 1, wherein the extraction chamber and the dispensing chamber are separated by one of a flexible diaphragm and a piston.

8. The apparatus of claim 1, wherein at least one of the extraction chamber and the dispensing chamber is at least partially contained within a pouch.

9. The apparatus of claim 1, further comprising a rate adjustment mechanism to control the rate at which water is transported through the water-transporting membrane.

10. The apparatus of claim 1, wherein the water-transporting membrane is configured to repel the osmagent.

11. A method to provide controlled delivery of a beneficial agent, the method comprising:
receiving water into a water chamber;
filtering the water received into the water chamber to produce filtered water;
transporting the filtered water through a water-transporting membrane in communication with the water chamber;
receiving the filtered water into an extraction chamber containing an osmagent, the filtered water expanding the extraction chamber; and
contracting a dispensing chamber in response to expanding the extraction chamber, wherein contracting the dispensing chamber causes a beneficial agent to be dispensed from the dispensing chamber.

12. The method of claim 11, wherein filtering the water comprises passing the water through a filter substantially adjacent to the water-transporting membrane.

13. The method of claim 11, wherein filtering the water comprises passing the water through a filter substantially adjacent to an inlet of the water chamber.

14. The method of claim 11, wherein filtering the water comprises passing the water through filter media containing activated carbon.

15. The method of claim 11, wherein filtering the water comprises passing the water through a microporous membrane to physically strain the water.

16. The method of claim 11, wherein filtering the water comprises removing impurities from the water using at least one of the following filtering mechanisms: physical straining, chemical absorption, and ion-exchanging.

17. The method of claim 11, wherein the extraction chamber and the dispensing chamber are separated by one of a flexible diaphragm and a piston.

18. The method of claim 11, wherein at least one of the extraction chamber and the dispensing chamber is at least partially contained within a pouch.

19. The method of claim 11, further comprising providing a rate adjustment mechanism to control the rate at which water is transported through the water-transporting membrane.

20. The method of claim 11, wherein the water-transporting membrane is configured to repel the osmagent.
